SEQUENCE LISTING (2 sequences)

SEQ ID NO: 1 - DNA, 20 bp, Artificial
  primer-bind
ccctcatagttagcgtaacg

SEQ ID NO: 2 - DNA, 20 bp, Artificial
  primer-bind
gatggttgttgtcattgtcg

(19) United States
(12) Patent Application Publication
(10) Pub. No.: US 2011/0257045 A1
(43) Pub. Date: Oct. 20, 2011

(54) METHOD FOR PREPARING HIGH-THROUGHPUT SEQUENCEABLE DNA FROM INDIVIDUAL PLAQUES OF PHAGES PRESENTING PEPTIDES

(75) Inventors: Bastian Budde, Koln (DE); Amber Riblett, Philadelphia, PA (US); Sascha Plug, Leverkusen (DE); Jürgen Benting, Leichlingen (DE)

(73) Assignee: BAYER TECHNOLOGY SERVICES GMBH, LEVERKUSEN (DE)

(21) Appl. No.: 13/126,517

(22) PCT Filed: Oct. 21, 2009
(86) PCT No.: PCT/EP2009/007526

§ 371 Date: Jul. 6, 2011

(30) Foreign Application Priority Data
Nov. 3, 2008 (DE) 10 2008 055 606.8

(51) Int. Cl. C40B 50/06

(52) U.S. Cl. 506/26

(57) ABSTRACT

The present invention relates to a process for isolating DNA from individual plaques of peptide-presenting bacteriophages in a high-throughput capacity PCR, wherein the PCR products obtained are sequenceable and a specimen of each phage studied is retained in a replicable state. The PCR is successful despite the presence of inhibitory constituents from the growth medium or the host bacteria.

The present invention relates to a process for isolating DNA from individual plaques of peptide-presenting bacteriophages in a high-throughput PCR, wherein the PCR products obtained are sequenceable and a specimen of each phage studied is retained in a replicable state. The PCR is successful despite the presence of inhibitory constituents which originate from, for example, the growth medium or the host bacteria.

Bacteriophages (phages for short) are virus-like particles which are able to infect bacteria and use them as specific host cells for replication. They consist of one or more envelope proteins which surround the phage genome (ssDNA or dsDNA).

An important biotechnological application for bacteriophages uses the direct coupling of genotype with phenotype. Owing to genetic modification of the phage genome by means of incorporation of corresponding oligonucleotide sequences into the DNA, peptides, protein parts or entire proteins can be coupled (fused) to envelope proteins of the phage and are thus presented on the surface of the phage. If a portion of the oligonucleotide sequences ligated into the DNA is randomized, this results in a correspondingly large library of phages which carry correspondingly randomized peptides (phage display library).

Such libraries are used, for example, for identifying binding partners by carrying out a repetitive selection process (biopanning) in which library phages initially interact with a substrate via their presented peptides and subsequently weakly binding or non-binding phages are washed away. This technique (phage display) is used, for example, for screening protein-protein interactions. A further possible application is the identification of phages as selective adhesion promoters which are self-organizing as the case may be. The coupling of an inorganic substrate to biological components to modify surface properties is known in biomimetics. Bacteriophages presenting short peptides and selected from a phage library have, for example, been used to date to precipitate and to deposit inorganic materials (WO2003/078451). Hybrid materials consisting of an inorganic substrate and specific polypeptide ligands are also used as a potential solution for altering the substrate surface. The concept of a bifunctional ligand for binding two inorganic components is addressed in the prior art (see, for example, Sarikaya et al., Nature Materials, 2003, 2, 577-585). The binding of cells or biomolecules to a polymer substrate by means of bacteriophages having bifunctional binding properties is described in, for example, WO2004/035612. It is possible to use bacteriophages in order to improve the adhesion of a coating material (e.g. a paint) on surfaces to be coated (e.g. a polymer workpiece). It is equally possible to use phages for promoting adhesion of an active substance to a substrate in order, for example, to bind active substances in a targeted manner to a target, to guide active substances in a targeted manner into a region of the body or to achieve a time-delayed release of active substances.

In summary, there is thus a great need for the production, isolation and identification of phages having specific properties for a variety of applications.

The selection of phages from a phage library in which the phages present a variety of different peptides is known in the prior art (Sarikaya et al., Nature Materials, 2003, 2, 577-585; O'Neil and Hoess, Current Opinion in Structural Biology, 1995, 5, 443-449; Smith and Scott, Methods in Enzymology 1993, 217, 228-257; Sambrook and Russell (editors), 2001, Molecular cloning: A laboratory manual (third edition), Cold Spring Harbor Press, pages 18.115 to 18.122).

For the evolutive selection of a few phage species from a large combinatorial phage population on a substrate, a phage display library is usually exposed to a substrate so that the binding of a few phages can take place. Weakly binding or non-binding phages are washed off by using a wash buffer. After washing, phages still binding are subsequently detached (eluted) by using another buffer (elution buffer). The eluted phages are replicated and exposed to the substrate again in further panning rounds until a population of strongly binding phages accumulates. After each panning round, the phage clones are usually thinned out in a plaque assay on agar plates and a sufficiently large number of phage plaques is selected by way of a random sample and picked from the growth medium. These are then multiplied (amplified) separately in a lengthy process in host cells, separated from the host cells, and purified and concentrated by means of repeated precipitation in order to obtain a sufficiently large amount of DNA for the following steps. Owing to lysis of the protein envelope, the DNA of the phage clones is purified and concentrated by subsequent precipitation. This DNA can then be used as a template for a polymerase chain reaction (PCR) in order to determine its base sequence (DNA sequencing according to the Sanger method). What is determined in the sequencing is usually the base sequence of only the DNA segment in which the phage clones differ.

In many cases, the size of the random sample of clones checked for their sequence is 10. However, if more accurate information about the accumulation of a clone or the occurrence of a binding motif needs to be obtained, sequencing of 50-100 phage clones is often necessary.

Although in the prior art there are high-throughput processes for preparing sequenceable DNA (sequencing templates), these processes invariably require larger amounts of fermented phage suspension as a source of DNA without using the time-saving and efficient PCR method. However, obtaining the phage suspensions from the individual plaques invariably requires several hours of fermentation in host bacteria. Isolation of the DNA according to Wilson (Biotechniques 1993, 15(3), pages 414-422), for example, is achieved by sodium iodide treatment of phage suspensions with subsequent ethanol precipitation or magnetic separation. Haas and Smith (Biotechniques 1993, 15(3), pages 422-41) describe preparation of the DNA from phage suspensions by means of alkali hydrolysis. In DE3724442A1, the DNA is purified from phage suspensions over glass-fibre filters. In DE69008825T2, the inventors replace the centrifugation steps with filtration processes. Kolner et al. (DNA Seq. 1994, 4(4), pages 253-257) use a semi-automatic cell harvester, but require as well larger amounts of phage suspensions. DNA preparation from individual plaques is described in Wang et al. (Biotechniques 1995, 18(1), pages 130-135). However, here as well no replicable phages survive owing to the lifting method used. Vaiman (Biotechniques 2002, 33(4), pages 764-766) uses PCR technology to screen large 2 gene libraries, but with loss of replicability of the individual phages and also the risk of contamination owing to formation of “superpools”.

According to the prior art, the selection of phage species from a combinatorial phage population comprises the following steps:
1) incubating a phage display library with a substrate,
2) separating the phages binding and not binding to the substrate,
3) determining the sequence of the presented peptide of some of the binding phages,
4) amplifying the binding phages,
5) repeating steps 1 to 4 multiple times if necessary; the amplicon of the binding phages forms the new library.

Determining the binding peptide sequence of the phage clones consists of the following steps:
a) thinning out the phages from the binding phage population obtained in step 2 on a growth medium covered with host bacteria by plating out an appropriate dilution of the phages,
b) separately amplifying a sufficiently large sample of binding phage clones,
c) separating the individual phage clones from the host cells,
d) purifying and concentrating the phage clones,
e) isolating the DNA of the individual binding phage clones,
f) purifying and concentrating the DNA,
g) sequencing the DNA by means of a polymerase chain reaction according to the Sanger method,
h) determining the identity (sequence) of the binding peptide by translating the DNA sequence.

This established approach according to the prior art involves many process steps between the thinning out of the phages in the plaque assay and the sequencing of the DNA which are time-consuming and error-prone. Also, the number of specimens which can be processed in parallel is limited. Against the background of the great importance outlined above of phages and of the multiplicity of possible applications, it would be desirable to be able to accelerate and parallelize the process of identifying phages suitable for the respective intended use. Also desirable would be the possibility of obtaining the phages in a replicable state so that phage clones of interest can be replicated separately after sequencing and used for other purposes.

Thus, proceeding from the prior art, it is an object of the invention to provide a process which is for preparing DNA of candidate phage clones from a phage population and which is more cost-effective and less time-consuming compared with the known processes according to the prior art, allows the parallel processing of a larger number of specimens, and allows replication of selected phage clones in their host bacteria after sequencing.

Surprisingly, a high-throughput capacity process for preparing DNA of phages was found which, while retaining a replicable specimen, generates sequenceable DNA directly from phage plaques without the need for the laborious steps of phage amplification and DNA isolation. It was found that, surprisingly, phages after isolation on a growth medium containing host bacteria (plaque assay) can be suspended in a medium directly after picking and also lysed with subsequent optimized PCR. A replicable specimen remains of each phage clone.

Therefore, the present invention relates to a process for the high-throughput capacity preparation of sequenceable DNA from individual plaques of peptide-presenting phages with the simultaneous retention of infectious phages, comprising at least the following steps:
A thinning out peptide-presenting phages from a phage population on a growth medium containing host bacteria,
B amplifying the isolated phages by means of incubation until a sufficient amount is available,
C picking the phages from the growth medium and suspending them in a suitable medium,
D lysing a portion of the suspended phages from step C and also using this DNA-containing lysate as a template in a polymerase chain reaction (PCR).

The term “peptide” is also used here as a synonym for the terms “protein” and “protein part”. Bacteriophages are able to bind to a substrate via presented peptides (or proteins or protein parts). These peptides are gene products of the phage genome, which form the envelope of the bacteriophage for example. A binding peptide does not have to be present on the natural form of the phage (“wild type”), but can, for example, be presented on the phage by means of manipulations of the phage genome using molecular genetics methods. Such a binding peptide is, for example, fused to other peptides/proteins of the bacteriophage, meaning that it is bonded either N-terminally or C-terminally to the other protein/peptide via a peptide bond.

A first step of the process according to the invention is the thinning out of peptide-presenting phages from a phage population (A). Methods for thinning out microorganisms and cells are known to a person skilled in the art in the field of microbiology Thinning out can, for example, be carried out by plating out an appropriate dilution of the phages (wherein the appropriate dilution can be determined empirically) on a growth medium containing corresponding host bacteria (e.g. an agar plate).

In a second step of the process according to the invention, the thinned out phages are amplified (e.g. by means of incubation) until a sufficient amount of phages is available (B). Sufficient amount is to be understood to mean an amount which makes it possible to perform the subsequent steps of the process according to the invention, more particularly the picking of the phages in step (C). Preferably, a sufficient amount is understood to mean an amount which is visible to the human eye and which can be picked with a suitable tool (e.g. a pipette tip).

After amplification, the phages are picked from the growth medium in a third step of the process according to the invention with a suitable sterile tool and the phage-, bacteria- and growth-medium-containing specimen thus obtained (the “agar plug”) is suspended in a medium suitable for storing the phages (C). A suitable medium is one in which the infectivity of the phages is maintained therein. To this end, suitable conditions in the medium regarding hydrophilicity and polarity of the solvent and also pH and ionic strength have to be specified. Preference is given to using to this end an aqueous solution having an approximately neutral pH (e.g. a buffer) and also having a suitable salt content. Suitable media are, for example, LB medium (lysogeny broth) and PBS (phosphate-buffered saline). If the phages used impart antibiotic resistance to the host bacteria, it is advantageous to add this antibiotic to the medium used in order to avoid growth of contaminating bacteria. In the high-throughput process, picking can, for example, take place in sterile 96-well plates. In the subsequent PCR reaction (D), many constituents present in the phage plug (e.g. culture medium, agar, cell debris) normally have an inhibitory effect, but it was found that, surprisingly, a sequenceable PCR product is formed under the following conditions:
1. The agar plaque is picked from the growth medium with a suitable sterile tool. A suitable tool is one with which it is possible to completely transfer the plaque from the growth medium to a working vessel without removing large portions of the residual growth medium as well. A suitable tool is, for example, a tubular instrument which has an inner diameter corresponding to the outer diameter of the agar plaque and with which the agar plaque can be pricked out. In a preferred embodiment, use is made of a sterile disposable pipette tip or a Pasteur pipette to prick out the plaque and to subsequently blow out the agar plug into the medium using a pipette.
2. The picked phage clone is suspended in the medium and subsequently exposed to an input of energy, preferably ultrasonic treatment. Equally possible are vortexing and also mechanical crushing of the agar plug. These procedures evidently promote the transfer of the phages from the growth medium into the medium.
3. The volume of the medium should exceed the volume of the agar plug many times over, preferably by a factor of from 2 to 10. Preference is given to selecting a volume in which the agar plug is completely covered in the vessel used. In a preferred embodiment, an agar plug picked using a disposable pipette tip is suspended in from 20 to 100 μl of medium in a well of a 96-well plate.
4. The suspension needs to be freshly processed. Preferably, the lysis of the clone with subsequent

PCR is carried out within 16 hours, particularly preferably within 8 hours. If a day has already passed between the picking of the clone and the PCR reaction, errors may occur in the amplification of the template DNA. Evidently, a sufficiently large amount of inhibitory substances diffuses from the agar plug into the medium over this time span to impede the amplification of the template DNA.

A small portion of the suspension thus obtained is treated with a lysis buffer and also subjected to a lysis step in order to uncover the DNA of the phages. The larger portion of the phage suspension can remain in the 96-well plates and is thus available for later specific amplifications of individual phage clones of interest. The lysis buffer contains a buffer substance in an aqueous solution at a slightly alkaline pH, a surfactant and also a complexing agent. Preferably, the buffer substance used is in a pH range of ≧8 to ≦9, the surfactant used is a non-denaturing, non-ionic substance, and the chelating agent used is one which complexes divalent metal ions. Particularly preferably, the buffer substance used is Tris, Tricine, Bicine or TAPS at a pH of 8.3, the surfactant used is an octylphenol ethoxylate (e.g. Triton X-100 or Nonidet-P40) or a Polysorbate (e.g. Tween® 20), and the complexing agent used is EDTA, EGTA, citrate, oxalate or tartrate. In a preferred embodiment, 10 mM Tris-HCl (pH 8.3), 1% (w/v) Triton X-100 and also 10 mM EDTA are used. The lysis step comprises heating the suspension to a temperature between ≧40° C. and ≦100° C., preferably to a temperature between ≧80° C. and ≦98° C., particularly preferably to a temperature between ≧93° C. and ≦97° C.

Subsequently, the suspension undergoes an optimized PCR (D). It was found that, surprisingly, the variable region of the phage clone DNA can be amplified error-free, despite the presence of inhibitory constituents of the suspension, when both the above-described conditions for the suspension and lysis steps are observed and an amount of dimethyl sulphoxide (DMSO) is present in the PCR reaction. According to the invention, an amount of between 0.1 and 50% by weight of DMSO is added to the PCR buffer. Preferably, between 1 and 30% DMSO, and particularly preferably, between 5 and 15% DMSO are added to the PCR buffer. In a preferred embodiment, about 10% DMSO is used.

Usually, it is necessary to separate the template DNA from other constituents before a PCR can be carried out, since the other constituents can disrupt or even prevent the multiplication of the template DNA. It was found that, surprisingly, the above-described conditions make it possible to omit isolation, purification and concentration of the phage DNA. Surprisingly, constituents such as culture medium, agar, and also remnants of the host cells, exhibit no inhibitory effect on the PCR in the process according to the invention. As a result, it is possible to carry out the DNA preparation process in a shorter time, with less effort, and at lower costs and reduced error-proneness with a larger number of specimens.

The process can be followed by sequencing of the phage DNA, for example according to the Sanger method. The determined sequence of the variable region of the phage clone DNA allows the amino acid sequence of the binding peptide to be inferred. The determined DNA sequence can also be used to genetically modify other phages in such a way that they present the same bindable peptides as fusion proteins.

In the event that the phages differ only in the binding peptide, preferably only the part of the phage DNA responsible for encoding the variable peptides is multiplied by means of PCR. This is achieved by selecting two suitable primers which bind to binding sites just before and just after the variable region of the phage DNA. Preferably, the primers are selected such that the amplicon resulting from the PCR has a size of between ≧60 and ≦500 bp.

The process according to the invention is, in general, appropriate for all phages which can form a plaque. It is preferably used for preparing DNA from clones of phage display libraries.

In a particular embodiment, the process according to the invention is preferably suitable as a DNA preparation process for phages which present at least one kind of randomized peptides fused to their envelope proteins and having a length of from ≧1 amino acid to ≦100 amino acids, preferably from ≧5 amino acids to ≦50 amino acids, particularly preferably from ≧6 amino acids to ≦20 amino acids. The peptides may be linear, but may also be looped. Peptides having such a number of amino acids can be easily fused to the phage proteins by means of conventional molecular biology methods and are suitable for binding to substrates. Examples of such peptides are linear peptides having a length of 7 amino acids, linear peptides having a length of 12 amino acids or looped peptides having a length of 7 amino acids which are framed by a disulphide bond between two cysteine residues. Such short-chain binding peptides have the advantage that the DNA of the various phages in the observed phage population is largely identical and only has differences in the regions of the DNA which encode the binding peptides. Thus, PCR can be adapted to short DNA segments (≧60 and ≦500 bases) in a targeted manner, and this has the advantage that the same primer and the same PCR conditions can be used for all picked clones.

In a particular embodiment, the process according to the invention is preferably suitable as a DNA preparation process for M13 phages. These phages are easily modifiable and readily available (for example, from New England Biolabs GmbH, Frankfurt, Germany) and readily replicable in culture. Their gene products are the proteins gpIII, gpVI, gpVII, gpVIII and gpIX. At least one additional short peptide can be fused to the protein gpIII or gpVIII. The extension of these proteins with additional peptides, i.e. the fusion, can be easily carried out on these proteins.

Advantageously, commercially available M13 phage display libraries are used which have a randomized peptide as a gpIII fusion protein, more particularly as a linear peptide having a length of 7 amino acids, as a linear peptide having a length of 12 amino acids, or as a looped peptide having 7 amino acids which are framed by a disulphide bond between two cysteine residues (trade names Ph.D.-7™, Ph.D.-12™ and Ph.D.-C7C™).

In a preferred embodiment, the process according to the invention is a constituent of a selection process for substrate-binding phage species from a library presenting randomized peptides. For the purposes of the invention, a binding phage has the property of being able to form a bond with at least one substrate via a presented peptide fused to an envelope protein of the phage. This technology is known to a person skilled in the art as “phage display”.

The present invention will be explained in more detail below with the aid of figures and examples, but without restricting it thereto.

In the figures,

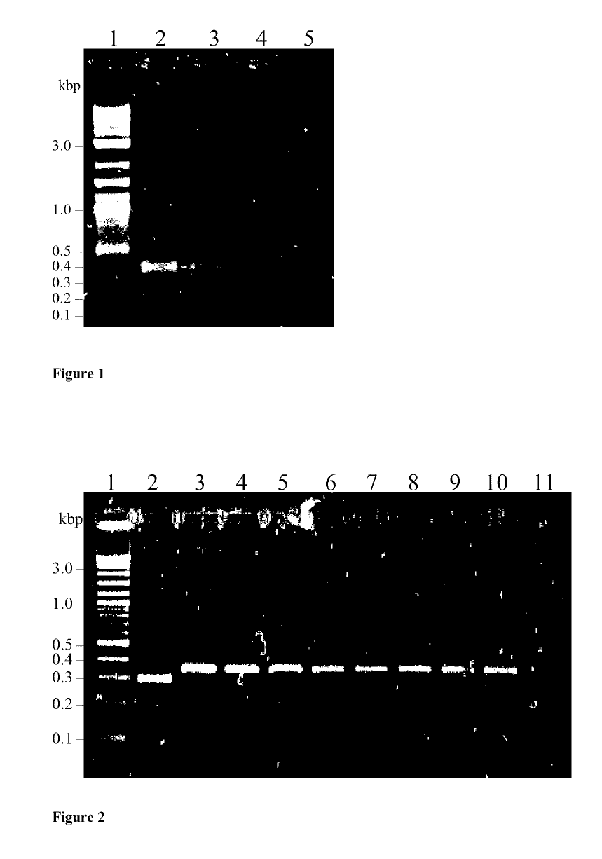

FIG. 1 shows the result of a PCR which was carried out with, as a source of DNA, differently treated M13 phage plaques. The PCR products were loaded onto a 1.2% (w/v) agarose gel and subjected to electrophoresis. The agarose gel was stained with ethidium bromide and photographed under UV light. 1: DNA size marker; 2: complete, intact phage plaque; 3: phage plaque suspended in LB medium according to the invention; 4: positive control (purified phage DNA); 5: negative control (without DNA template). As a source of DNA, the phage plaque suspended in LB medium according to the invention (lane 3) delivers a product qualitatively equivalent to that of the purified phage DNA (lane 4). The complete plaque can be used equally successfully as a source of DNA (lane 1), but no intact phages remain from this specimen for a subsequent amplification. Despite the high number of 40 PCR cycles, no artefacts at all are found in the negative control (lane 5).

FIG. 2 shows the result of a PCR which was carried out with, as a source of DNA, M13 phage plaques suspended in LB medium. The PCR products were loaded onto a 1.2% (w/v) agarose gel and subjected to electrophoresis. The agarose gel was stained with ethidium bromide and photographed under UV light. 1: DNA size marker; 2-9: plaques of different phage clones; 10: positive control (purified phage DNA); 11: negative control (without DNA template). Easily discernible are the high-quality 334 by PCR products of the specimens (lanes 3-9) and also of the positive control (lane 10). The faster running phage clone DNA in lane 2 was identified in subsequent sequencing as a phage without an insert (corresponds to M13KE without library insert). The negative control (lane 11) shows, as expected, no artefacts at all.

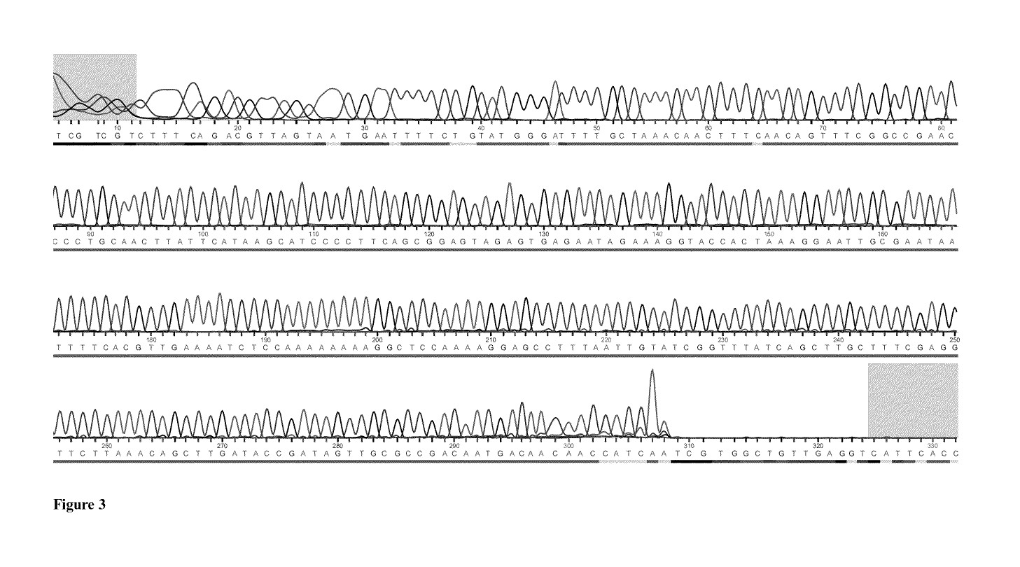

FIG. 3 shows a typical elution profile of DNA sequencing which was carried out on a PCR product according to the invention of a phage plaque with the primer “−96gIII” (5′-CCCTCATAGTTAGCGTAACG-3′; see example). The phage clone originates from a Ph.D.-12™ M13 phage display library. The variable DNA region of interest of the phage clone (positions 89-124) has a high sequence quality.

### EXAMPLE

### DNA Isolation of M13 Phage Clones which Accumulate on a Polyurethane Substrate During Panning of a Combinatorial Phage Display Library (Ph.D.-12™, New England Biolabs)

Polyurethane substrate was produced from a mixture of equivalent amounts of Desmophen® 670 BA and Desmodur® N3300 (Bayer MaterialScience AG) and cured over 16 h at room temperature. 20 mg of the substrate were equilibrated for 10 min in Tris-buffered saline (TBS, consisting of 50 mmol/1 Tris-HCl, pH 7.5, 150 mmol/l NaCl) and incubated at room temperature for 60 min with 4*10¹⁰ pfu (10 μl of the original library) in 1 ml TBS. The substrate was washed ten times with 10 ml of TBST (TBS plus 0.1% per volume of Tween 20) each time (by means of brief vortexing, five-minute rotation plus 5 s in an ultrasonic bath). The first elution was carried out under acidic conditions by immersing the substrate in 1 ml of 0.1 mol/l glycine, pH 2.5 for 10 s with subsequent neutralization of the substrate in 1 ml of 0.1 mol/l Tris-HCl, pH 8 for 1 min The first elution solution was neutralized by adding 200 μl of 1 mol/l Tris-HCl, pH 8. The second elution was carried out under basic conditions by immersing the substrate in 1 ml of 0.1 mol/l triethylamine, pH 11.5 for 1 min with subsequent neutralization of the substrate in 1 ml of 0.1 mol/l Tris-HCl, pH 7.5 for 1 min. The second elution solution was neutralized by adding 200 μl of 1 mol/l Tris-HCl, pH 7.5. The substrate was subsequently stored in TBST in order to monitor temporal detachment effects of non-eluted phages.

From the elution fraction, a plaque assay was subsequently carried out. For this purpose, bacteria of the strain E. coli K12 ER2738 (New England Biolabs) were spread out on an LB-Tet agar plate (15 g/l agar, 10 g/l Bacto tryptone, 5 g/l yeast extract, 5 g/l NaCl, 20 mg/l tetracycline) and incubated overnight at 37° C. 10 ml of LB-Tet medium (10 g/l Bacto tryptone, 5 g/l yeast extract, 5 g/l NaCl, 20 mg/l tetracycline) were inoculated with an individual colony of ER2738 and shaken at 37° C. until the OD₆₀₀ was 0.4. 400 μl of this bacterial suspension were admixed with 10 μl of undiluted elution solution, pipetted into 3 ml of melted LB-Top agar (7 g/l agar, 10 g/l Bacto tryptone, 5 g/l yeast extract, 5 g/l NaCl), vortexed, and distributed on a LB-IPTG/X-gal plate (15 g/l agar, 10 g/l Bacto tryptone, 5 g/l yeast extract, 5 g/l NaCl, 1.25 mg/l isopropyl-β-D-thiogalactopyranoside, 1 mg/l 5-bromo-4-chloro-3-indolyl-β-D-galactopyranoside). The plate was incubated overnight at 37° C. Each of the resulting blue plaques is a phage clone.

80 blue, well-separated plaques were punched out from the agar plate using sterile 1000 μl pipette tips and transported by means of a 1000 μl pipette into one well each of a sterile 96-well plate, where each well had been initially charged with 100 μl of LB-Tet medium. The 96-well plate was tightly sealed with PCR strips and treated with ultrasound for 1 min in an ultrasonic bath. Immediately afterwards, 5 μl each of the phage clone suspension thus obtained were pipetted into a well each of a new 96-well plate which had been initially charged with 24 μl of lysis buffer (10 mM Tris-HCl, pH 8.3, 10 mM disodium EDTA, pH 8.0, 1% (w/v) Triton X-100). A negative control, 5 μl of H₂O, and a positive control, a mixture of 2 μl of H₂O and 3 μl of purified M13 phage DNA of a clone of the phage display library Ph.D.-12™ (New England Biolabs), were pipetted into two further wells of the same 96-well plate.

The phage DNA for the positive control was isolated in the following way and purified: 2 ml of LB-Tet medium were inoculated with 100 μl of an E. coli ER2738 bacterial suspension (see above) and also with a blue plaque from a plaque assay and shaken at 37° C. for 4.5 h. The culture was centrifuged at 4500×g and 4° C. for 10 min and the supernatant was then centrifuged again. 1 ml of the supernatant was admixed with 500 μl of PEG/NaCl solution and incubated at 4° C. for 2 h. The phages were centrifuged at 14 000×g and 4° C. for 15 min and re-suspended in 100 μl of 10 mM Tris-HCl, pH 8.0, 1 mM EDTA, 4 M NaI. The DNA was precipitated for 10 min by adding 250 μl of ethanol and centrifuged at 14 000×g and 20° C. for 15 min The pellet was washed with 70% ethanol, centrifuged at 14 000×g and 20° C. for 1 min, dried, and re-suspended in 30 μl of 10 mM Tris-HCl, pH 8.0.

The 96-well plate was tightly sealed with PCR strips. The phages were lysed by heating the plate to 95° C. in a thermal cycler for 20 min. Subsequently, the PCR was carried out. To this end, 26 μl of PCR master mix, which had the following composition, were pipetted into each well:

| | Concentration | |
|---|---|---|
| Volume [μl] | in reaction | Component |
| 5 | 1× | 10× PCR buffer |
| | | (including 15 mM MgCl₂) |
| 0.5 | 10 mM | MgCl₂ solution (1M) |
| | (overall: 11.5 mM) | |
| 1 | 200 μM each | dNTP mix |
| | | (stock: 10 mM each) |
| 5 | 0.1 μM | Reverse primer “−96g111” |
| | | (1 pmol/μl) |
| 5 | 0.1 μM | Forward primer “M13KE_F1” |
| | | (1 pmol/μl) |
| 0.125 | 1.25 U | Taq polymerase (5 U/μl) |
| 5 | 10% (v/v) | Dimethyl sulphoxide (100%) |
| 4.375 | | H₂O |

The PCR primers have the following sequence:

| Reverse primer (Gen III): | |
|---|---|
| −96gIII | 5′-CCCTCATAGTTAGCGTAACG-3′ |
| Forward primer (Gen VIII): | |
| M13KE_F1 | 5′-GATGGTTGTTGTCATTGTCG-3′ |

In the case of the Ph.D.-12™ phage library used, which is based on the M13KE vector, the primers enclose a 334 by long region which contains the 36 by long variable sequence of each phage clone. PCR cycling was carried out in a thermal cycler under the following conditions:

| 1. | 30 | sec | 95° C. |
|---|---|---|---|
| 2. | 30 | sec | 52.2° C. |
| 3. | 30 | sec | 72° C. |
| 4. | 39 repetitions of steps 1-3 | | |
| 5. | 5 | min | 72° C. |

The PCR products were separated on a 1.2% agarose gel in TAE buffer (40 mM Tris, 20 mM acetic acid, 50 mM disodium EDTA, pH 8.0). In this way, a random sample of 8 specimens was analysed with regard to their quality (FIG. 2).

A volume of 10 μl each of each PCR product was pipetted into a new 96-well plate and dried at 50° C. in a drying cabinet for 3 h. Subsequently, the plate was sealed with a self-adhesive aluminium foil and sent to a DNA sequencing service provider (Eurofins MWG Operon). There, the specimens were sequenced with the primer −96gIII according to the dideoxy method (see FIG. 3). The DNA sequence thus obtained of each specimen represents the anticodon strand of the template and was first converted into the complementary sequence. It was then subsequently possible to determine the amino acid sequence of the variable region with the aid of the reduced genetic code (Ph.D.-12™ Phage Display Peptide Library Kit Instruction Manual, Version 2.7 (2006), New England Biolabs).

1. Process for the high-throughput capacity preparation of sequenceable DNA from individual plaques of peptide-presenting phages with the simultaneous retention of infectious phages, comprising at least the following steps:
A thinning out peptide-presenting phages from a phage population on a growth medium containing host bacteria,
B amplifying the thinned out phages by means of incubation,
C picking the phages from the growth medium and suspending them in a medium,
D lysing a portion of the suspended phages from step C and also using this DNA-containing lysate as a template in a polymerase chain reaction (PCR).

2. Process according to claim 1, wherein, in step C, phage plague is picked from the growth medium with a sterile tool and, by this means, the plague is pricked out from the agar plate to yield an agar plug and subsequently the agar plug is transferred into the medium.

3. Process according to claim 2, wherein the suspending in step C is carried out with an input of energy.

4. Process according to claim 3, wherein the volume of the medium is at least twice that of the agar plug and the agar plug is completely covered in the vessel used for the suspending.

5. Process according to claim 4, wherein the lysis in step D is carried out within 8 hours at most subsequent to step C.

6. Process according to claim 5, wherein the lysis in step D is carried out by adding an aqueous lysis buffer which comprises at least one buffer substance, one surfactant and one complexing agent.

7. Process according to claim 1, wherein the lysis in step D comprises heating to a temperature between 80° C. and 98° C.

8. Process according to claim 1, wherein, in step D, an amount of between 1 and 30% by weight of DMSO is added to the PCR.

9. A selection process for the binding phages from a phage display library, said selection process comprising a process according to claim 1.
